(19) United States
(12) Patent Application Publication
(10) Pub. No.: US 2009/0083797 A1
(43) Pub. Date: Mar. 26, 2009

(54) METHOD FOR DISPLAYING EXTRA INFORMATION AND VIDEO APPARATUS THEREOF

(75) Inventors: Soo-Yeoun Yoon, Suwon-si (KR); Min-kyu Park, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronis Co., Ltd., Suwon-si (KR)

(21) Appl. No.: 12/037,225

(22) Filed: Feb. 26, 2008

(30) Foreign Application Priority Data
Sep. 20, 2007 (KR) 2007-96089

(51) Int. Cl. H04N 5/445

(52) U.S. Cl. 725/43

(57) ABSTRACT

A method for displaying extra information and a video apparatus thereof. The method includes displaying the image, receiving a user's command to display the extra information on a specific area of the display, and displaying the extra information on the specific area, and shifting the image out of the specific area, such that a portion of the image is displayed.

### CROSS-REFERENCE TO RELATED APPLICATION

This application claims the benefit of Korean Application No. 2007-96089, filed Sep. 20, 2007, in the Korean Intellectual Property Office, the disclosure of which is incorporated herein by reference.

### BACKGROUND OF THE INVENTION

1. Field of the Invention

Aspects of the present general inventive concept relate to a method for controlling a video apparatus, and a video apparatus employing the same, and more particularly, to method for displaying extra information, and a video apparatus employing the same.

2. Description of the Related Art

Video apparatuses refer to apparatuses that reproduce or record an image from a recording medium, or from a broadcast transmission. With the rapid development of video and broadcasting technologies, video apparatuses provide various kinds of content. Also, owing to the advent of digital television and internet television, which are also video apparatuses, viewers enjoy a large amount of content, and can also get extra information relating to the content, through the video apparatuses.

The extra information is displayed on the video apparatus in several ways. A first way is to overlap the extra information on an image; a second way is to create a picture in picture (PIP) window, reduce an image size, and display the extra information on a remaining area; and a third way is to display the extra information on a separate display.

However, the first way has a problem, in that the extra information may hinder image display, even if the extra information is displayed in a semitransparent state, and in addition, the amount of the extra information has to be limited somewhat, in order to minimize obstructing the displayed image. The second way causes an inconvenience to viewers, since the PIP window is small, and thus, limits the display of the extra information. Finally, the third way has a problem in that changing to a different display, to review the extra information, reduces the relationship between the image and the extra information.

### SUMMARY OF THE INVENTION

Aspects of the present general inventive concept provide a method for displaying extra information, which selectively displays extra information on a selected area of a display, and displays part of an image, if the extra information is displayed, thereby providing both the extra information and the image more conveniently, and a video apparatus employing the same.

Aspects of the general inventive concept may be achieved by providing a method for displaying an image and extra information about the image. The method includes displaying the image, dividing the extra information into specific categories, and displaying the divided extra information on a selected area of a display.

According to aspects of the present teachings, the method may further include displaying a marker, to select extra information about the image.

Aspects of the general inventive concept may also be achieved by providing a method for displaying extra information in a video apparatus. The method includes: displaying at least one of an image, and extra information about the image, on a display; receiving a user's command to display the extra information on a specific area of the display; displaying the extra information on the specific area, and displaying a portion of the image in the remaining area of the display.

According to aspects of the present teachings, the extra information may include first extra information, to be displayed on the top side of the display, second extra information to be displayed on the left side of the display, third extra information to be displayed on the bottom side of the display, and fourth extra information to be displayed on the right side of the display.

If the first extra information is displayed, the image may be shifted downward, and may be displayed without a lower portion thereof. If the second extra information is displayed, the image may be shifted to the right, and may be displayed without a right portion thereof. If the third extra information is displayed, the image may be shifted upward, and may be displayed without an upper portion thereof. If the fourth extra information is displayed, the image may be shifted to the left, and may be displayed without a left portion thereof.

According to aspects of the present teachings, if the image is produced from a broadcast signal, the extra information may be based on metadata received in the broadcast signal.

According to aspects of the present teachings, the method may further include dividing the broadcasting signal into an image signal and metadata, dividing the metadata into a plurality of categories, and individually storing the divided metadata as extra information.

According to aspects of the present teachings, if the video apparatus is connected to the Internet, the extra information may be obtained through the Internet.

According to aspects of the present teachings, the method may further include extracting a keyword relating to the image, and obtaining extra information through the Internet, using the keyword.

According to aspects of the present teachings, the image displaying operation may display the image, along with a marker indicating that extra information can be displayed on a selected area of the display.

According to aspects of the present teachings, the marker may refer to directional information.

According to aspects of the present teachings, provided is a broadcast receiving apparatus, which receives a broadcast signal that includes extra information. The apparatus includes a broadcast receiving unit to receive the broadcast signal, an extra information dividing unit to divide the broadcast signal into an image signal and extra information, an extra information processing unit to divide the extra information into categories, an extra information storage unit to store the divided extra information by categories, a signal processing unit to process at least one of the image and the extra information into a reproducible signal, a display unit to display the reproducible signal, and a controller to read the extra information from the extra information storage unit. The controller can apply the extra information to the signal processing unit, such that the extra information is selectively displayed with the image, according to a user's manipulation command.

According to aspects of the present teachings, the extra information processing unit may divide the extra information into categories using metadata, and the display unit may separately display the divided extra information on one or more different areas of the display unit.

According to aspects of the present teachings, the display unit may display markers, indicating that the extra information can be displayed.

According to aspects of the present teachings, provided is a video apparatus including a display unit to display an image and/or extra information about the image, and a controller to control the display the extra information, on a selected area of the display unit. The controller controls the display unit to shift the image away from the selected area, and to display a portion of the image on the remaining area of the display, according to a user's command to display the extra information on the selected area of the display unit.

According to aspects of the present teachings, the extra information may include first extra information to be displayed on a top side of the display unit, second extra information to be displayed on a left side of the display unit, third extra information to be displayed on a bottom side of the display unit, and fourth extra information to be displayed on a right side of the display unit.

According to aspects of the present teachings, if a command to display the first extra information is input, the controller may display the first extra information on the top side of the display unit, and simultaneously shift the image downward, such that the image is displayed without a lower portion thereof. If a command to display the second extra information is input, the controller may display the second extra information on the left side of the display unit, and simultaneously shift the image to the right, such that the image is displayed without the right side thereof. If a command to display the third extra information is input, the controller may display the third extra information on the bottom side of the display unit, and simultaneously shift the image upward, such that the image is displayed without the upper portion thereof. If a command to display the fourth extra information is input, the controller may display the fourth extra information on the right side of the display unit, and simultaneously shift the image to the left, such that the image is displayed without the left side thereof.

According to aspects of the present teachings, if the image is a broadcast signal, the extra information may be based on metadata received with the broadcast signal.

According to aspects of the present teachings, the video apparatus may further include: an extra information dividing unit to divide the broadcast signal into an image signal and metadata; and an extra information processing unit to divide the metadata into a plurality of categories, and to individually store the divided extra information, according to the categories.

According to aspects of the present teachings, if the video apparatus is connected to the Internet, the extra information may be obtained through the Internet.

According to aspects of the present teachings, the video apparatus may further include an extra information search unit to extract a keyword relating to the image, and to obtain extra information through the Internet, using the keyword.

According to aspects of the present teachings, the controller may display the image, along with marker indicating that the extra information can be displayed on a specific area of the display unit.

According to aspects of the present teachings, the marker may relate to direction information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following description of the exemplary embodiments, taken in conjunction with the accompanying drawings, of which:

FIG. 1 is a block diagram illustrating a broadcast-receiving, video apparatus, according to an exemplary embodiment of the present general inventive concept;

FIG. 2 is a flowchart illustrating a process of receiving a broadcast, and displaying an image and extra information, according to an exemplary embodiment of the present general inventive concept;

FIG. 3 is a view illustrating an example of extra information, according to an exemplary embodiment of the present general inventive concept;

FIGS. 4A to 4E are views to explain a method of displaying extra information, during a process of reproducing an image, according to an exemplary embodiment of the present general inventive concept;

FIG. 5 is a view illustrating the method of displaying the extra information of FIGS. 4A to 4E, according to a user's perspective; and

FIGS. 6A to 6C are views to explain a method for changing the content of extra information.

### DETAILED DESCRIPTION OF THE EXEMPLARY EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below, in order to explain the aspects of the present general inventive concept, by referring to the figures.

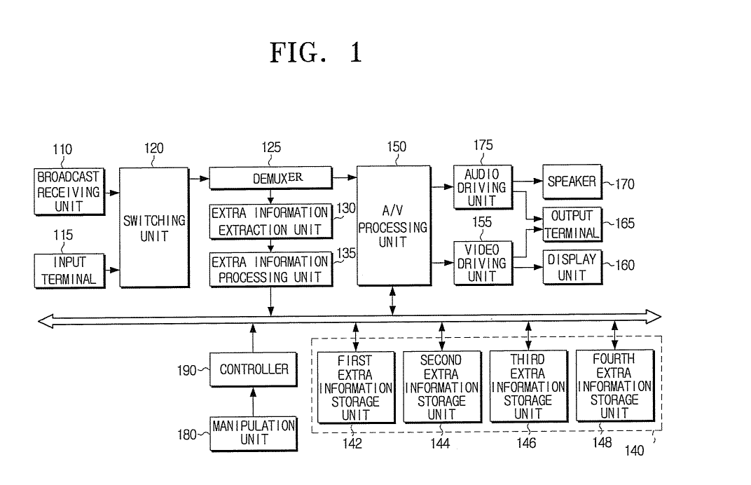

FIG. 1 is a block diagram illustrating a broadcast receiving apparatus, according to an exemplary embodiment of the present general inventive concept. As shown in FIG. 1, the broadcast receiving apparatus includes a broadcast receiving unit 110, an input terminal 115, a switching unit 120, a demuxer 125, an extra information extraction unit 130, an extra information processing unit 135, an extra information storage unit 140, an A/V processing unit 150, a video driving unit 155, a display unit 160, an output terminal 165, a speaker 170, an audio driving unit 175, a manipulation unit 180, and a controller 190. The broadcast receiving apparatus is shown as an example of a video apparatus. A video apparatus can be refer to any apparatus that reproduces an image recorded on a recording medium, and/or reproduces an image from an external transmission.

The broadcast receiving unit 110 tunes to and demodulates a TV broadcast signal. The input terminal 115 provides a communication interface, to communicably connect to an external device. The external device connected to the input terminal 115 can be, for example a PC, a camera, a DVD player, a PMP, a HDD player, a USB memory stick, and/or a memory card. However, these are merely examples, and any device having a recording medium embedded therein, to store an image, can serve as the external device. The input terminal 115 is connected to the external device, for example, in a wired or wireless manner.

The switching unit 120 performs a switching operation, such that one of outputs of the broadcast receiving unit 110 or the input terminal 115, is transmitted to the demuxer 125. The switching operation of the switching unit 120 is controlled by the controller 190.

The demuxer 125 divides a broadcast signal from the broadcast receiving unit 110 into an image signal (video and/or audio) and a second signal. The demuxer 125 applies the image signal to the A/V processing unit 150, and applies the second signal to the extra information extraction unit 130. According to a signal output from the input terminal 115, the demuxer 125 applies main data, corresponding to an image to the A/V processing unit 150, and other data, to the extra information extracting unit 130.

The extra information extraction unit 130 extracts extra information from the signal output from the demuxer 125. The demuxer 125 and the extra information extracting unit 130 are referred to as an extra information dividing unit.

The extra information relates to content. For example, if the content is a broadcast signal, the extra information can be metadata configured according to standards set by the TV-Anytime Forum. If the content is a photograph from a user, the extra information can be information added to the photograph by a user, for example, shooting time information and/or shooting location information. Such extra information is not required to be reproduced every time that the content is reproduced, and instead, is selectively displayed, according to a user's display command.

If the extra information extraction unit 130 outputs several types of extra information, the extra information processing unit 135 groups the extra information into categories, according to characteristics of the extra information. A grouping criterion for the extra information may be set by a manufacturer of a video apparatus, or may be set by a user. The extra information processing unit 135 may group the extra information into four different types (first through fourth) of extra information. The grouped extra information is separately stored in the extra information storage unit 140.

The extra information storage unit 140 stores the extra information, and may include first through fourth extra information storage parts 142, 144,146, and 148. The first through fourth extra information are stored in the respective first through fourth extra information storage parts 142, 144,146, and 148.

The A/V processing unit 150 processes the image signal (video and/or audio) transmitted from the switching unit 120, to reproduce the image signal. The A/V processing unit 150 transmits a video signal to the video driving unit 155, and transmits an audio signal to the audio driving unit 175.

The video driving unit 155 outputs an image signal and/or extra information to the display unit 160, or transmits the same to another external device (not shown) connected thereto, through the output terminal 165.

The audio driving unit 175 outputs an audio signal from the A/V processing unit 150, through the speaker 170, or transmits the audio signal to another external device (not shown) connected thereto, through the output terminal 165.

The manipulation unit 180 receives a user's manipulation command, and transmits the manipulation command to the controller 190, as will be described below. The manipulation unit 180 may be an integrated unit, or a split unit, with respect to the broadcast receiving apparatus. The manipulation unit 180 may be a user interface that provides a menu display, through which a user inputs a command. The manipulation unit 180 may be a remote controller, through which a user inputs a manipulation command, and a light receiving part to receive an output signal from the remote controller, and to transmit the output signal to the controller 190. In this exemplary embodiment, the manipulation unit 180 will be mainly described in terms of a remote controller.

The controller 190 controls the operation of the broadcast receiving apparatus, based on a user's command applied from the manipulation unit 180. In particular, if a command to display extra information, on a specific area of the display unit 160, is input during the reproduction of content, the controller 190 controls the A/V processing unit 150 and the extra information storage unit 140, to read out the extra information from the extra information storage unit 140, to display the extra information on the specific area of the display unit 160, and to simultaneously display an image on the remaining area of the display unit 160. The controller 190 may display one or more markers, indicating that extra information can be displayed on a specific area of the display unit 160, along with an image.

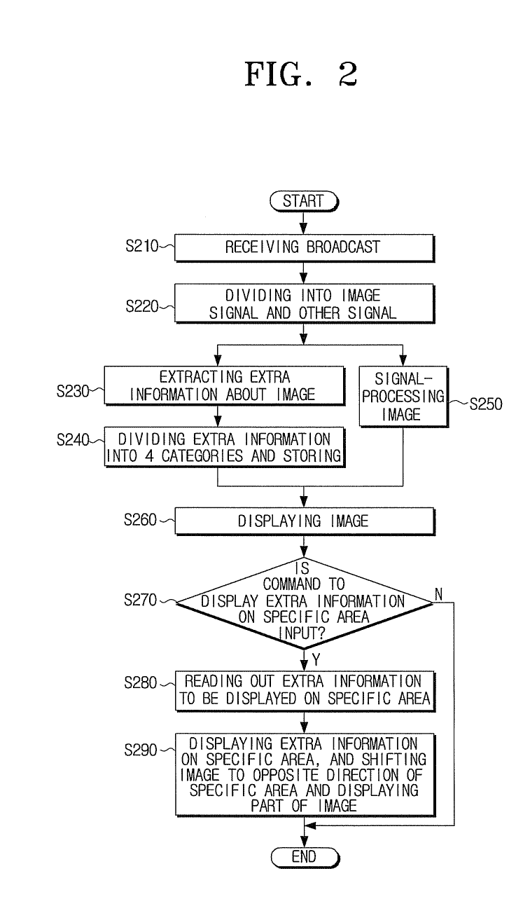

FIG. 2 is a flowchart illustrating a process of receiving a broadcast, and displaying an image and extra information, according to an exemplary embodiment of the present general inventive concept. If the broadcast receiving unit 110 receives a broadcast signal (S210), the demuxer 125 divides the broadcast signal into an image signal and an extra data signal, applies the image signal to the A/V processing unit 150, and applies the extra data signal to the extra information extraction unit 130 (S220).

The extra information extracting unit 130 extracts extra information about an image, from the extra data signal output from the demuxer 125, and applies the extra information to the extra information processing unit 135 (S230). The extra information processing unit 135 divides the extra information into, for example, four categories, and stores the divided extra information in the respective extra information storage parts 142,144,146, and 148 (S240).

The A/V processing unit 150 processes the image signal into a displayable image signal (S250). The displayable image signal output from the A/V processing unit 150 is displayed on the display unit 160 (S260).

The controller 190 determines whether a command to display extra information, on a specific area of the display unit 160, is input (S270). If a user wishes to see extra information about an image that he/she is viewing, the user inputs an extra information display command, to select one or more markers displayed on the specific areas of the display, where the extra information is to be displayed. In other words, the user selects a marker displayed on a particular area of the display unit 160, such that corresponding extra information is displayed on the particular area of the display unit 160. The controller 190 determines that an extra information command has been input.

If the extra information display command is input (S270-Y), the controller 190 reads out extra information from the extra information storage unit 140, to display the extra information on the specific area (S280). For example, if a first extra information display command is input, the controller 190 reads out extra information from the first extra information storage part 142, to display the first extra information in an area corresponding to the marker.

The controller 190 displays the extra information on the specific area of the display unit 160, simultaneously shifts an image output from the A/V processing unit 150, away from the specific area, and displays a portion of the image on a remaining area of the display (S290). More specifically, the read extra information is processed by the A/V processing unit 150, such that the A/V processing unit 150 alternately applies the image and the extra information to the video driving unit 155, every time that a horizontal synchronization signal and a vertical synchronization signal are input.

For example, it is assumed that 12 horizontal synchronization signals and 6 vertical synchronization signals are input, in order to display one scene. First extra information, which has been read out from the first extra information storage part 142, and the signal processed by the A/V processing unit 150, is output on the display unit 160, until the first through sixth horizontal synchronization signals are input. Part of the image is output on the display unit 160, until the seventh through the twelfth horizontal synchronization signals are input. Second extra information, which has been processed at the A/V processing unit 150, is displayed on the display unit 160, until first through third vertical synchronization signals are input, and a part of the image is displayed until the fourth through sixth vertical synchronization signals are input.

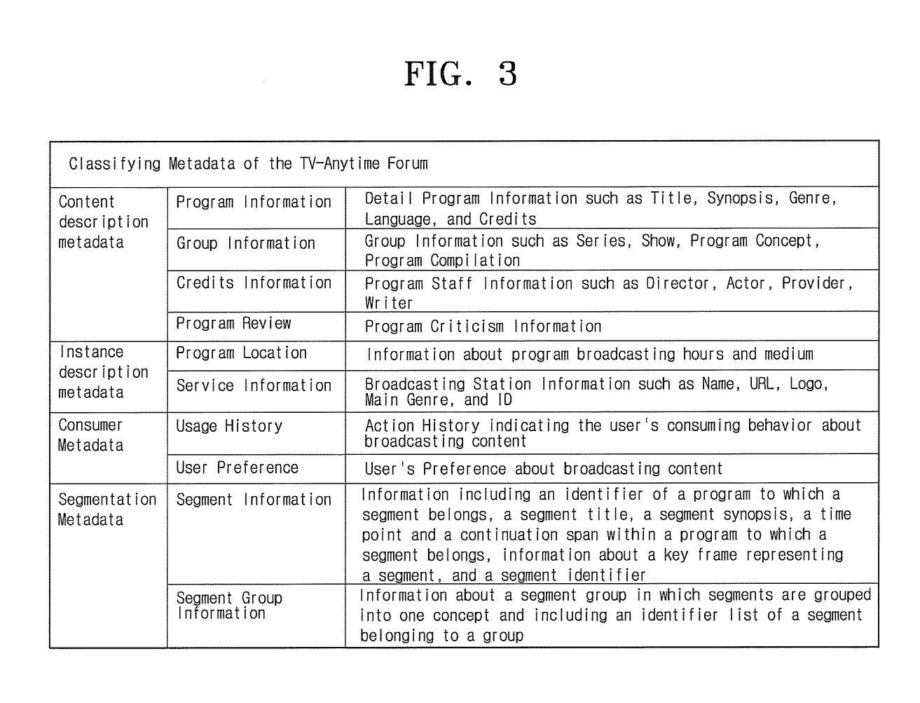

FIG. 3 is a view illustrating an example of extra information, according to an exemplary embodiment of the present general inventive concept. The extra information relates to content. If the content is broadcast, the extra information is metadata configured according standards set by the TV Anytime Forum. As shown in FIG. 3, the metadata format prescribed by the TV-Anytime Forum includes program information, segment group information, and the like. The extra information processing unit 135 classifies ‘Content description metadata’ as first extra information, ‘Instance description metadata’ as second extra information, ‘Consumer metadata’ as third extra information, and ‘Segmentation metadata’ as fourth extra information. The classified extra information is stored in the extra information storage unit 140.

If the image is derived from a broadcast signal, the extra information is displayed, based on the metadata included in the broadcast signal. If the broadcast receiving apparatus is linked to the Internet, more diverse extra information can be provided. For example, if the broadcast receiving apparatus is provided with an extra information searching unit (not shown), it is possible to search extra information on the Internet, based on a keyword extracted from the metadata, or a keyword described in the image. Thus, a related image, a motion picture, a blog, news, shopping information, and/or viewers' opinions can provided, as extra information.

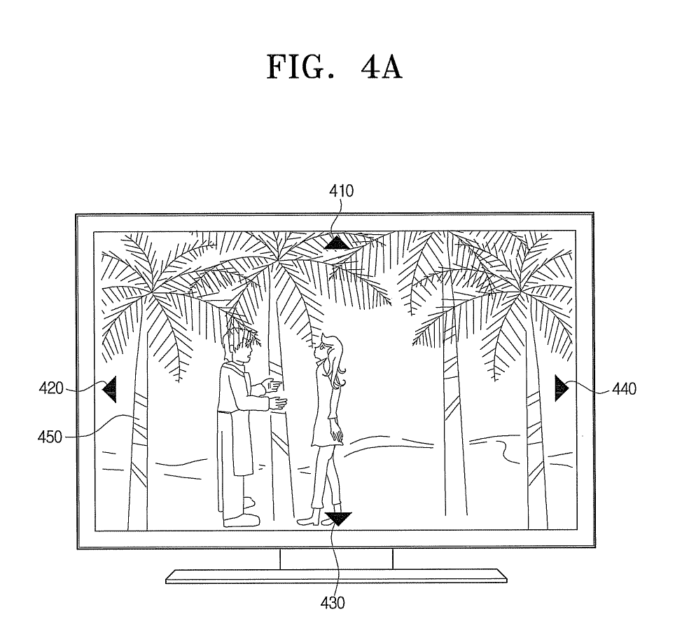

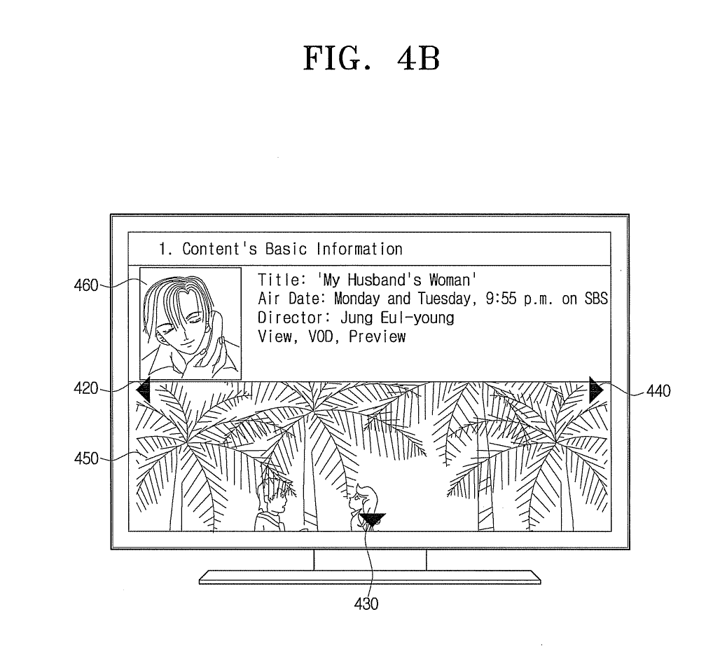

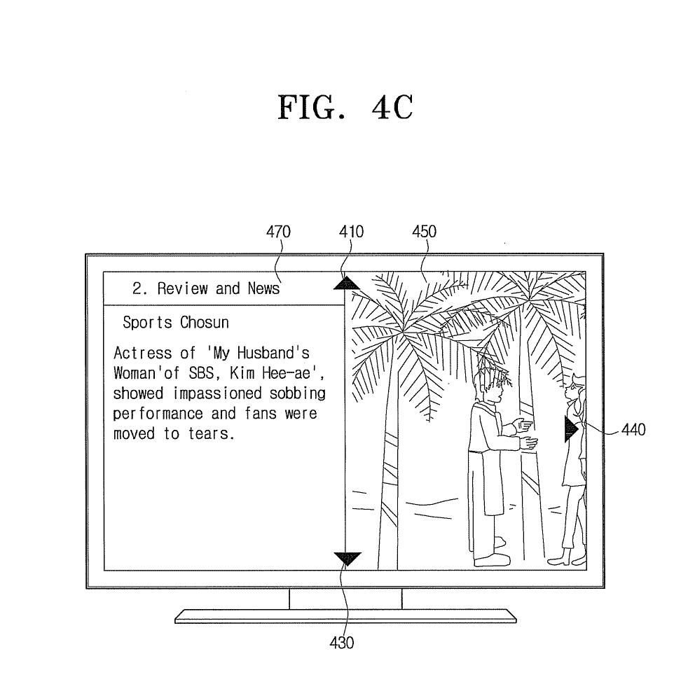

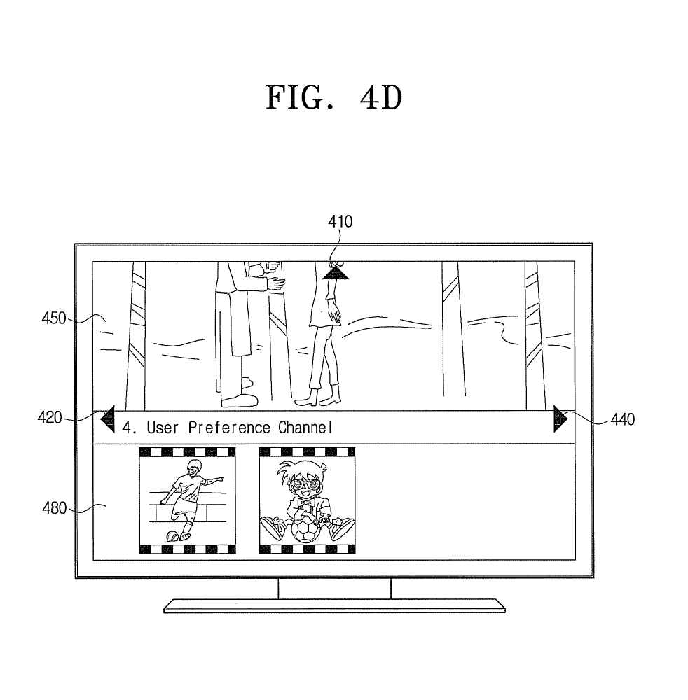

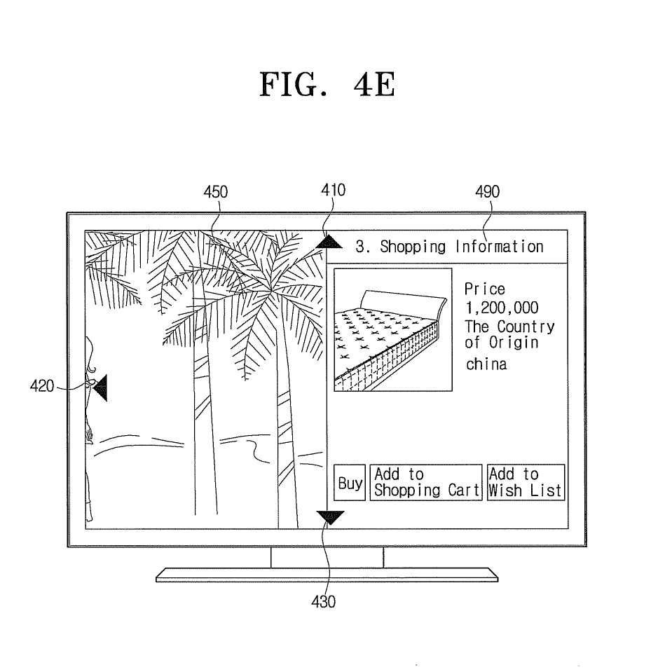

FIGS. 4A to 4E are views to explain a method for displaying extra information, during the reproduction of an image, according to an exemplary embodiment of the present general inventive concept. As shown in FIG. 4A, an image 450 is displayed on the entire area of the display unit 160. Markers 410, 430, 420, and 440, indicating that extra information can be displayed, are respectively displayed on the top, bottom, left, and right sides of the display unit 160.

If a user inputs a command to select the marker 410 located on the top side of the display unit 160, then the controller 190 controls the display unit 160, such that first extra information 460 is displayed on the top side of the display unit 160, and a part of the image is displayed on a remaining area of the display unit 160, as shown in FIG. 4B. In displaying a part of the image, the controller 190 excludes a lower portion of the image. The lower portion has an area that corresponds to the area used to display the first extra information 460. That is, the controller 190 shifts the image downward (away from the first extra information 460) as much as the first extra information is displayed and displays a part of the image on the remaining area of the display unit 160.

If the user selects the marker 420 located on the left side of the display unit 160, the controller 190 controls the display 160, such that second extra information 470 is displayed on the left side of the display unit 160, and the image shifts to the right side of the display 160. A portion of the image 450 is displayed on the remaining area, as shown in FIG. 4C.

In the same way, if the user selects the marker 430 or 440, located on the bottom and the right sides, the image and the extra information are displayed on the display unit 160, as shown in FIGS. 4D and 4E.

As described above, since the extra information is selectively displayed, the user is not required to stop reproducing the image he/she is viewing, in order to see extra information. The image also need not be resized. Since a variety of extra information is displayed on different areas of the display unit 160, no searching operation is required to see the extra information of a specific category. According to some exemplary embodiments, the extra information can be displayed in more than one area of the display unit 160 at a time.

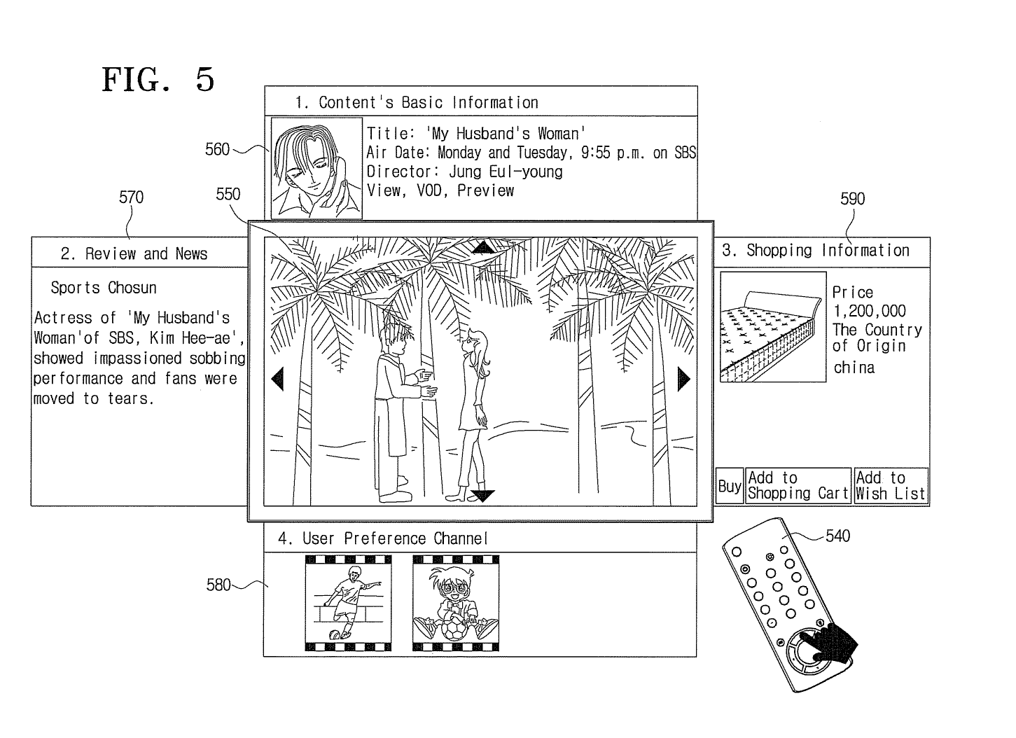

FIG. 5 is a view illustrating the method of displaying extra information of FIGS. 4A to 4E, according to a user's perspective. As shown in FIG. 5, the user views the display unit 160, which comprises an image display 550 and first through fourth extra information displays 560, 570, 580, and 590, and a TV frame. Accordingly, the use enjoys the image and the extra information, by moving the TV frame vertically and horizontally, using direction keys on a remote controller 540. Thus the intuitive manipulation of the video apparatus is possible, which provides for convenient manipulation.

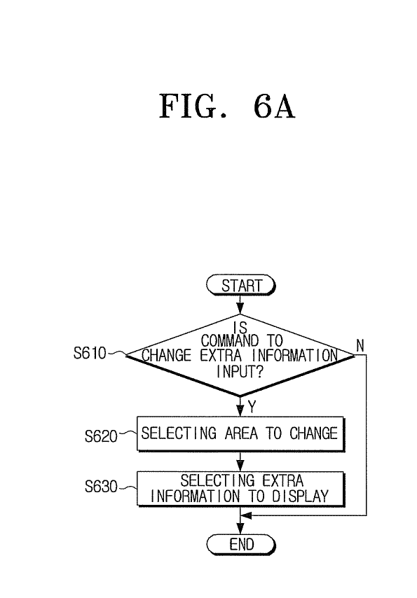

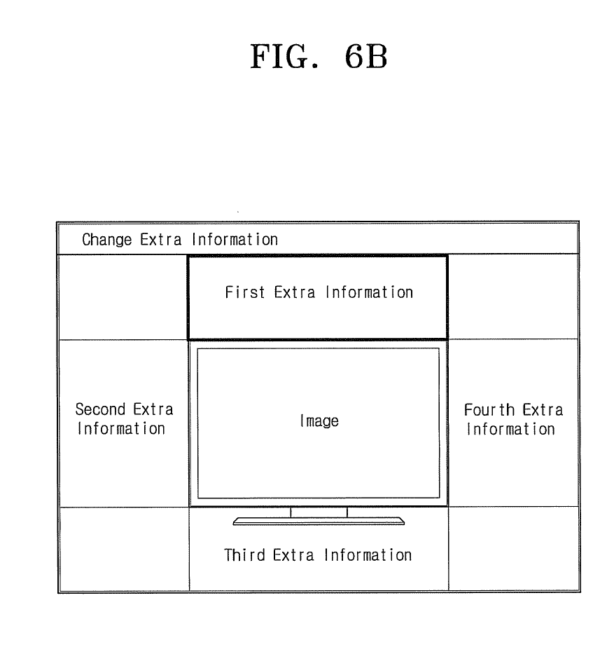

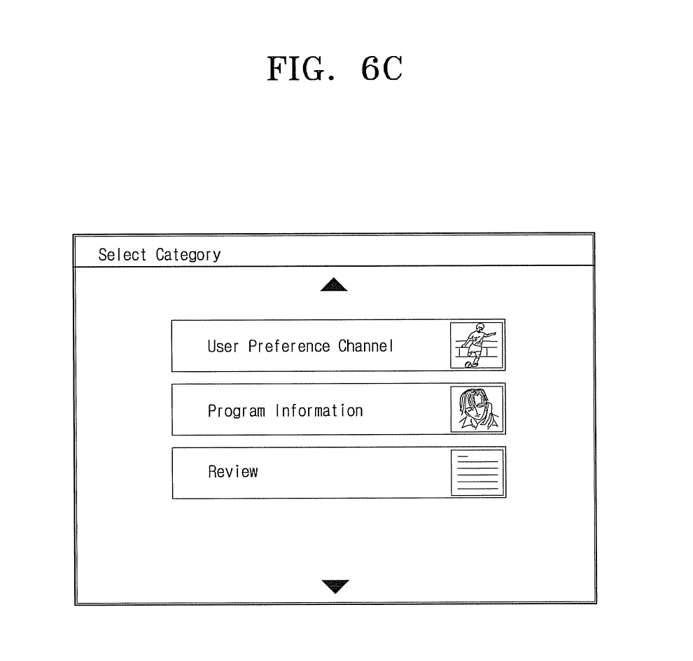

FIGS. 6A to 6C are views illustrating a method for changing content of extra information, according to an exemplary embodiment of the present general inventive concept. As shown in FIG. 3, metadata provides a wide variety of extra information. Since it may be difficult to display extra information belonging to one category on a single scene, the user may select particular extra information to be displayed, and/or a particular area in which the extra information is to be displayed.

Referring to FIGS. 6A to 6C, if a command to change the extra information is input (S610), the controller 190 controls the display 160, such that a graphical user interface (GUI) relating to the extra information, is displayed, as shown in FIG. 6B. The user selects an extra information area using direction and ‘OK’ keys on the remote controller (S620). The controller 190 controls the display 160, such that a list of extra information to be provided on the selected extra information area, is displayed on the display unit 160, as shown in FIG. 6C. The user selects the extra information to be displayed, from the list, using the direction and ‘OK’ keys on the remote controller (S630).

In the present exemplary embodiment, the video apparatus includes the manipulation unit 180 and the display unit 160, which are separated from each other. However, the present general inventive concept may be applicable to a touch screen panel that incorporates operations of the manipulation unit 180 in the display unit 160.

In the present exemplary embodiment, the extra information relates to a currently reproduced image. However, the user's preference channel information, a video-on-demand (VOD) linkage relating to the preference channel information, and information set by the user, may be displayed along with an image, in the same way as described above.

A video apparatus to provide various images and extra information, and a method for providing extra information more conveniently have been described. A video apparatus adopting this method is an apparatus that is capable of receiving a broadcast. However, this video apparatus is merely exemplary, for the convenience of explanation. There is no limitation in apparatuses to which the present general inventive concept is applicable. That is, the present general inventive concept is applicable to a TV, a set-top box, a DVD replay apparatus, a DVD recording apparatus, a video cassette recorder (VCR), a multimedia replay apparatus, a motion picture replay apparatus, a compact disk (CD) replay apparatus, a CD recording apparatus, an MP3 player, a mobile phone, a personal digital assistant (PDA), and an audio system, and a combination video apparatus integrating one or more of the above video apparatuses.

As described above, according to the exemplary embodiments of the present general inventive concept, the extra information is selectively displayed on a specific area of the display unit 160, by category, so that a user can enjoy the extra information and the image more conveniently.

Since the method and apparatus, according to the exemplary embodiments of the present general inventive concept, display extra information, by providing a virtual image including the extra information and the image, rather than overlapping the image, or resizing the image, the user can intuitively manipulate the display of the extra information.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion.

Although a few embodiments of the present general inventive concept have been shown and described, it would be appreciated by those skilled in the art that changes may be made in these exemplary embodiments, without departing from the principles and spirit of the general inventive concept, the scope of which is defined in the claims and their equivalents.

What is claimed is:

1. A method for displaying an image and extra information related to the image, the method comprising:
displaying the image on a display;
dividing the extra information into categories; and
moving the image out of a portion of the display, and displaying one of the categories of the extra information on the portion of the display.

2. The method as claimed in claim 1, further comprising displaying a marker at the portion, to indicate that the extra information can be displayed in the portion of the display.

3. A method for displaying extra information in a video apparatus comprising a display to display at least one of an image and extra information about the image, the method comprising:
displaying the image on the display;
receiving a user's command to display the extra information on an area of the display; and
displaying the extra information on the portion, by shifting the image on the display out of the portion, such that part of the image is not displayed on the display.

4. The method as claimed in claim 3, wherein the extra information comprises first extra information to be displayed on the top side of the display, second extra information to be displayed on the left side of the display, third extra information to be displayed on the bottom side of the display, and fourth extra information to be displayed on the right side of the display.

5. The method as claimed in claim 4, wherein,
if the user selects the first extra information, the image is shifted toward the bottom side of the display, such that a bottom portion of the image is not displayed;
if the user selects the second extra information, the image is shifted toward the right side of the display, such that a right portion of the image is not displayed and is displayed leaving out its right part;
if the user selects the third extra information, the image is shifted toward the top side of the display, such that a top portion of the image is not displayed; and
if the user selects the fourth extra information, the image is shifted toward the left side of the display, such that a left portion of the image is not displayed.

6. The method as claimed in claim 3, wherein the image corresponds to a broadcast signal and the extra information is based on metadata included in the broadcast signal.

7. The method as claimed in claim 6, further comprising:
dividing the broadcasting signal into an image signal and metadata;
dividing the metadata into categories; and
separately storing the categories as the extra information.

8. The method as claimed in claim 3, wherein, the extra information is obtained through the Internet.

9. The method as claimed in claim 3, further comprising:
obtaining the extra information through the Internet using a keyword related to the image.

10. The method as claimed in claim 3, wherein the displaying of the image comprises displaying markers on the display, which indicate that the extra information can be displayed.

11. The method as claimed in claim 10, wherein the markers relate to specific areas of the display where each of the categories of the extra information is to be displayed.

12. A broadcast receiving apparatus to receive a broadcast signal, the apparatus comprising:
a broadcast receiving unit to receive the broadcast signal;
an extra information dividing unit to divide the broadcast signal into an image signal and extra information;
an extra information processing unit to divide the extra information into categories;
an extra information storage unit to store the divided extra information;
a signal processing unit to process the image signal and/or the extra information into a displayable signal;
a display unit to display the displayable signal as an image; and
a controller to read out the extra information from the extra information storage unit, and to apply the extra information to the signal processing unit, such that the extra information is selectively displayed along with the image, according to a user's manipulation command.

13. The broadcast receiving apparatus as claimed in claim 12, wherein the extra information processing unit divides the extra information into categories using metadata, and the display unit displays the divided extra information on different areas of the display unit.

14. The broadcast receiving apparatus as claimed in claim 13, wherein the display unit displays a marker to indicate that the extra information can be displayed.

15. A video apparatus comprising:
a display unit to display an image and/or extra information about the image; and
a controller to display the extra information on an area of the display unit, and to shift the image away from the area of the display unit, such that only a portion of the image is displayed, according to a user's command to display the extra information on the area of the display unit.

16. The video apparatus as claimed in claim 15, wherein the extra information comprises first extra information to be displayed on the top side of the display unit, second extra information to be displayed on the left side of the display unit, third extra information to be displayed on the bottom side of the display unit, and fourth extra information to be displayed on the right side of the display unit.

17. The video apparatus as claimed in claim 16, wherein,
if a command to display the first extra information is input, the controller displays the first extra information on the top side of the display unit, and simultaneously shifts the image away from the top side, such that a bottom portion of the image is not displayed;
if a command to display the second extra information is input, the controller displays the second extra information on the left side of the display unit, and simultaneously shifts the image away from the left side, such that a right portion of the image is not displayed;
if a command to display the third extra information is input, the controller displays the third extra information on the bottom side of the display unit, and simultaneously shifts the image away from the bottom side, such that a top portion of the image is not displayed; and
if a command to display the fourth extra information is input, the controller displays the fourth extra information on the right side of the display unit, and simultaneously shifts the image away from the right side, such that a left portion of the image is not displayed.

18. The video apparatus as claimed in claim 15, wherein the image relates to broadcast signal and the extra information is based on metadata received along with the broadcast signal.

19. The video apparatus as claimed in claim 18, further comprising:
an extra information dividing unit to divide the broadcast signal into an image signal and metadata; and
an extra information processing unit to divide the metadata into a plurality of categories, and to individually storing the categories as the extra information.

20. The video apparatus as claimed in claim 15, wherein the extra information is obtained through the Internet.

21. The video apparatus as claimed in claim 20, further comprising:
an extra information search unit to obtain the extra information through the Internet, using keyword related to the image.

22. The video apparatus as claimed in claim 15, wherein the controller displays markers on the image, which indicate that the extra information can be displayed.

23. The video apparatus as claimed in claim 22, wherein the markers relate to specific areas of the display unit where the extra information will be displayed.

24. The method as claimed in claim 1, further comprising displaying a graphical user interface, if a command to change the extra data is received from a user.

25. A method for displaying an image and extra information related to the image, the method comprising:
displaying the image on a display;
dividing the extra information into categories;
displaying markers, each associated with one of the categories and disposed at one of the top side, the bottom side, the right side, and the left side of the display;
receiving a user's selection identifying one of the markers; and
moving the image away from the side of the display associated with the selected marker, to vacate a portion of the display, and displaying one of the categories of the extra information associated with the selected marker, on the vacated portion of the display.

26. The method of claim 25, wherein a portion of the image is not displayed, after the moving of the image.
